(19) United States
(12) Patent Application Publication
(10) Pub. No.: US 2004/0078709 A1
(43) Pub. Date: Apr. 22, 2004

(54) System, method, and product for providing a test mechanism within a system area network device

(75) Inventors: Bruce Leroy Beukema, Hayfield, MN (US); Wen-Tzer Thomas Chen, Austin, TX (US); Danny Marvin Neal, Round Rock, TX (US); Renato John Recio, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/195,163

(22) Filed: Jul. 11, 2002

(51) Int. Cl. G06F 11/00

(52) U.S. Cl. 714/43

(57) ABSTRACT

A method, system, and product in a data processing system are disclosed for testing a switched area network device having a standardized serial fabric interconnect and that includes logic modules. The device includes test mode logic. A test command is received within the test mode logic via the standardized serial fabric interconnect from an external tester. The test command is then executed by the test mode logic, and a result of the test is then transmitted to the tester via the standardized serial fabric interconnect.

### BACKGROUND OF THE INVENTION

1. Technical Field

The present invention relates generally to the field of computer systems and, more specifically to a data processing system, method, and product for providing a test mechanism within a system area network device that utilizes a standard serial fabric interface.

2. Description of Related Art

Many existing computer systems use a shared-bus architecture, such as Peripheral Component Interconnect (PCI), as a means of transmitting data internally within the computer system among the system's various processors and I/O devices. These existing shared-bus architectures have not kept pace with the increase in the performance of typical processors. Thus, a new architecture, commonly called “Infiniband”, has been developed for transmitting data among processors and I/O devices internally within a computer system. This new architecture is capable of providing greater bandwidth and increased expandability.

The new architecture provides a system-area network which includes a channel-based, switched-fabric technology. In such a system-area network (SAN), data is transmitted via messages which are made up of packets. Each device, whether it is a processor or I/O device, includes a channel adapter. The messages are transmitted from one device's channel adapter to another device's channel adapter via switches. Each channel adapter may also be referred to as an “end node”.

The new architecture defines a physical interface for connecting system area network devices together. Each device that adheres to the architecture includes a standard physical interface that provides full duplex serial differential signaling and can be either 1-bit, 4-bits, or 12-bits wide (see the Infiniband Specification, Release 1.0a, Volume 2, published Jun. 19, 2001, for a detailed description of the physical interface). The system area network devices are physically connected to each other by connecting a link between each device's physical interface. This physical interface may also be called a serial fabric interconnect.

Testing of the system area network devices, and their logic components, has been accomplished in the prior art by providing a tester that is external to a device. In order to use the tester, a special tester interface must be provided on the device in addition to the standard physical interface. This special interface does not conform to the physical interface defined by the new architecture.

FIG. 1 depicts a system area network device that has a modified physical interface coupled to a tester utilizing a modified link in accordance with the prior art. A device 100 is any one of the system area network devices, such as a host channel adapter, target channel adapter, switch, or router. A tester 102 may be coupled to device 100 utilizing a modified chip interface 104 to test the various logic functions 106 of device 100. Modified chip interface 104 is a special interface that does not conform to the standard, architectural interface. Interface 104 has a specialized set of pins, and thus needs a specialized link 108 to communicate with tester 102.

Device 100 may also include a standard interface 110 that does conform to the standard described by the architecture. Standard interface 110 includes a standardized pin set, and thus uses the standard link 112 to communicate with other system area network devices.

Therefore, a need exists for a method, system, and product that provides a test mechanism within a system area network device that utilizes the standard serial fabric interface defined by the architecture.

### SUMMARY OF THE INVENTION

A method, system, and product in a data processing system are disclosed for testing a switched area network device having a standardized serial fabric interconnect and that includes logic modules. The device includes test mode logic. A test command is received within the test mode logic via the standardized serial fabric interconnect from an external tester. The test command is then executed by the test mode logic, and a result of the test is then transmitted to the tester via the standardized serial fabric interconnect.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a system area network device that has a modified physical interface coupled to a tester utilizing a modified link in accordance with the prior art;

FIG. 2 illustrates a data processing system that implements a channel-based, switched fabric architecture for transmitting data in accordance with the present invention;

FIG. 3 depicts a functional block diagram of a host processor node in accordance with the present invention;

FIG. 4 illustrates a host channel adapter in accordance with the present invention;

FIG. 5 depicts a system area network device that includes test logic and includes a standard physical interface coupled to a tester utilizing a standard link in accordance with the present invention;

FIG. 6a illustrates a block diagram of a link training state machine in accordance with the present invention;

FIG. 6b depicts a block diagram of a packet that may be used as an echo packet in accordance with the present invention;

FIG. 7 depicts a more detailed block diagram of the link training state machine of FIG. 6a in accordance with the present invention; and

FIG. 8 illustrates a high level flow chart which depicts testing logic modules included within a system area network device in accordance with the present invention.

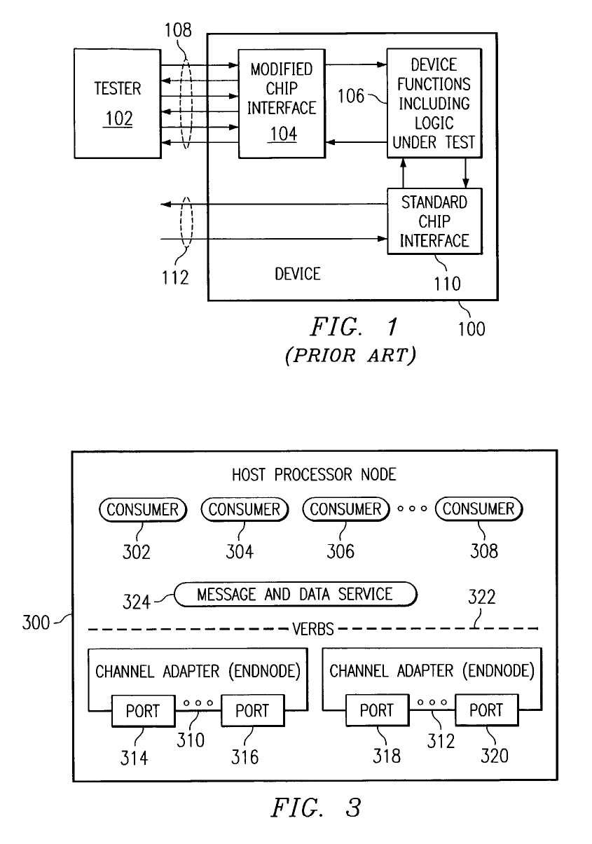

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a method, system, and product in a data processing system for testing a switched area network device having a standardized serial fabric interconnect and that includes logic modules. Test mode logic is included in the device. The device is coupled to an external tester via the standardized serial fabric interconnect. When the device is in a loopback test mode state, the test mode logic may receive test commands via the standardized serial fabric interconnect from the tester. Thus, the test mode logic communicates with the tester by sending and receiving commands in echo packets via the standardized serial fabric interconnect.

The test mode logic then tests the logic specified by the test command by executing the test command. The test mode logic then determines whether or not the specified logic passed or failed the test. The test mode logic then transmits the results of the test via an echo packet to the tester.

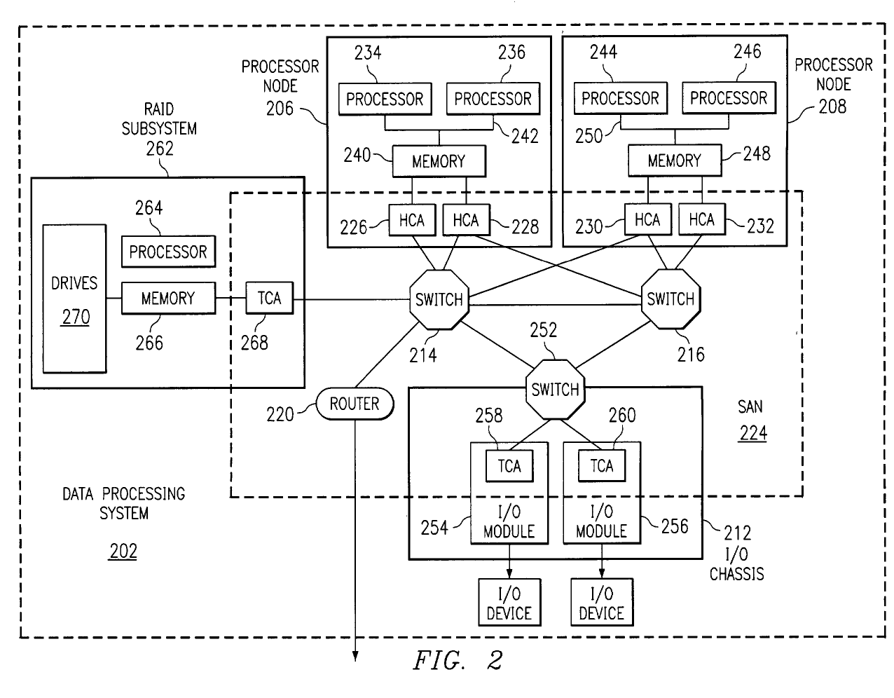

FIG. 2 depicts a data processing system that implements a channel-based, switched fabric architecture for transmitting data in accordance with the present invention. Computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by the Internet or an intranet.

Data processing system 202 includes a storage area network 224. A storage area network may also be referred to as a “subnet”. A subnet is a group of end nodes and cascaded switches that is managed as a single unit. Typically, a subnet occupies a single geographic or functional area. For example, a single computer system in one room could be defined as a subnet.

Data processing system 202 includes a high-bandwidth, low-latency network interconnecting nodes within the distributed computer system. A node is any component attached to one or more links of a network and forming the origin and/or destination of messages within the network. In the depicted example, data processing system 202 includes nodes in the form of host processor node 206, host processor node 208, redundant array independent disk (RAID) subsystem node 262, and I/O chassis node 212. The nodes illustrated in FIG. 2 are for illustrative purposes only, as SAN 224 can connect any number and any type of independent processor nodes, I/O adapter nodes, and I/O device nodes. Any one of the nodes can function as an end node, which is herein defined to be a device that originates or finally consumes messages or packets in SAN 224.

SAN 224 includes the communications and management infrastructure supporting both I/O and interprocessor communications (IPC). SAN 224 includes a switched communications fabric which allows many devices to concurrently transfer data with high-bandwidth and low latency in a secure, remotely managed environment. End nodes can communicate over multiple ports and utilize multiple paths through SAN 224.

SAN 224 includes host channel adapters (HCAS) 226, 228, 230, and 232, target channel adapters (TCAS) 258, 260, and 268, switches 214, 216, and 252, and router 220. A switch is a device that connects multiple links together and allows routing of packets from one link to another link within a subnet using a small header Destination Local Identifier (DLID) field. Generally, a switch can route packets from one port to any other port on the same switch.

A router is a device that connects multiple subnets together and is capable of routing packets from one link in a first subnet to another link in a second subnet using a large header Destination Globally Unique Identifier (DGUID).

A link is a full duplex channel between any two network fabric elements, such as end nodes, switches, or routers. Example suitable links include, but are not limited to, copper cables, optical cables, and printed circuit copper traces on backplanes and printed circuit boards.

Each node in data processing system 202 includes at least one channel adapter (CA). Each channel adapter is an end point that implements the channel adapter interface in sufficient detail to source or sink packets transmitted utilizing a storage area network (SAN) 224. SAN 224 may also be referred to as a fabric. A channel adapter included in a processor node is a host channel adapter (HCA). A channel adapter included in a node other than a processor node is a target channel adapter (TCA).

Host processor node 206 contains channel adapters in the form of host channel adapter 226 and host channel adapter 228. Host processor node 208 contains host channel adapter 230 and host channel adapter 232. Host processor node 206 also includes central processing units 234 and 236, and a memory 240 interconnected by bus system 242. Host processor node 208 similarly includes central processing units 244 and 246, and a memory 248 interconnected by a bus system 250.

Host channel adapter 226 provides a connection to switch 214. Host channel adapter 228 provides a connection to switches 214 and 216. Host channel adapter 230 provides a connection to switches 214 and 216. And, host channel adapter 232 provides a connection to switch 216.

Host channel adapters are preferably implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols.

I/O chassis 212 includes an I/O switch 252 in the I/O adapter backplane to couple adapter cards to SAN 224, and multiple I/O modules 254 and 256. In this example, the I/O modules take the form of adapter cards.

Adapter cards may include a SCSI adapter card, an adapter card to fiber channel hub and fiber channel-arbitrated loop (FC-AL) devices, an Ethernet adapter card, a graphics adapter card, or a video adapter card. Any known type of adapter card can be implemented.

Each I/O module includes a target channel adapter. I/O module 254 includes target channel adapter (TCA) 258, and I/O module 256 includes target channel adapter (TCA) 260.

A RAID subsystem node 262 is also included in data processing system 202. Node 262 includes a processor 264, a memory 266, a target channel adapter (TCA) 268, and multiple redundant and/or striped storage disk unit 270. Target channel adapter 268 can be a fully functional host channel adapter.

SAN 224 provides the I/O and interprocessor communications (IPC) consumers of the distributed computer system with zero processor-copy data transfers without involving the operating system kernel process, and employs hardware to provide reliable, fault tolerant communications.

FIG. 3 is a functional block diagram of a host processor node in accordance with the present invention. Host processor node 300 is an example of a host processor node, such as host processor node 206 or 208 depicted in FIG. 2.

Host processor node 300 includes a set of consumers 302, 304, 306, and 308 which are processes executing on host processor node 300. Host processor node 300 also includes channel adapters 310 and 312. Channel adapter 310 includes ports 314 and 316 while channel adapter 312 includes ports 318 and 320. Each port connects to a link utilizing a standardized physical interface. The standard physical interface provides full duplex serial differential signaling and can be either l-bit, 4-bits, or 12-bits wide.

Consumers 302-308 transfer messages to the SAN, such as SAN 224, via the verbs interface 322 and message and data service 324. A verbs interface is essentially an abstract description of the functionality of a host channel adapter. An operating system may expose some or all of the verb functionality through its programming interface. This interface defines the behavior of the host. Message and data service 324 is a higher-level interface than the verb layer and is used to process messages and data received through channel adapters 310 and 312. Message and data service 324 provides an interface to consumers 302-308 to process messages and other data.

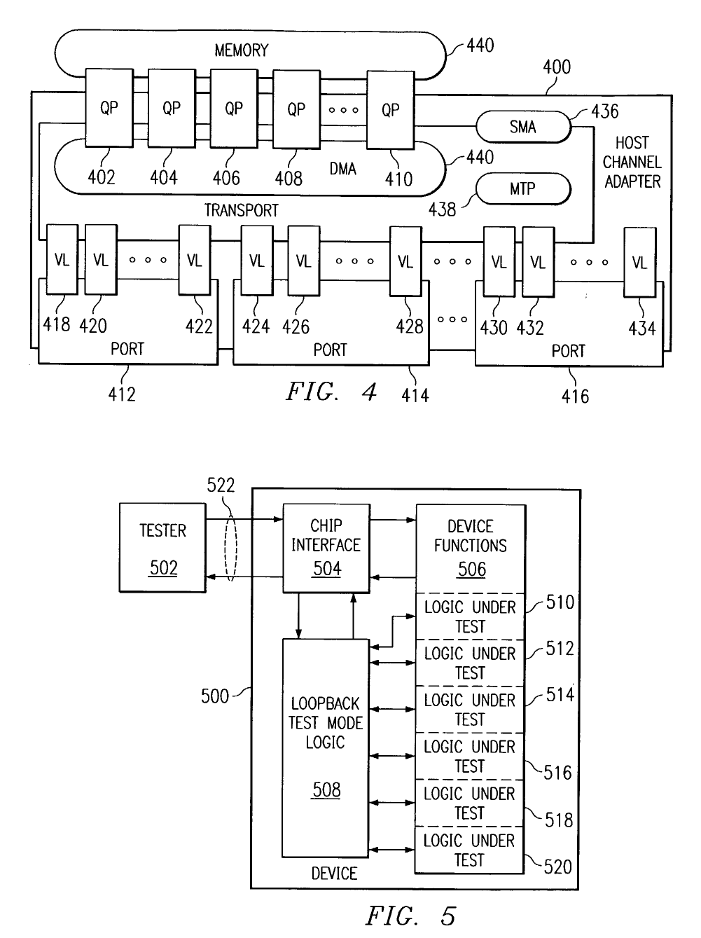

FIG. 4 illustrates a host channel adapter in accordance with the present invention. Host channel adapter 400 includes a set of queue pairs (QPs) 402-410, which are used to transfer messages to the host channel adapter ports 412-416. Buffering of data to host channel adapter ports 412-416 is channeled through virtual lanes (VL) 418-434 where each virtual lane has its own flow control. The subnet manager configures channel adapters with the local addresses for each physical port, i.e. the port's LID.

Subnet manager agent (SMA) 436 is the entity that communicates with the subnet manager for the purpose of configuring the channel adapter. Memory translation and protection (MTP) 438 is a mechanism that translates virtual addresses to physical addresses and validates access rights. Direct memory access (DMA) 440 provides for direct memory access operations using memory 440 with respect to queue pairs 402-410.

FIG. 5 depicts a system area network device 500 that includes loopback test mode logic 508 and includes a standard physical interface 504 coupled to an external tester 502 utilizing a standard link 522 in accordance with the present invention. Device 500 is a system area network device, such as a host channel adapter, a target channel adapter, a switch, or a router. Device 500 is capable of executing device functions 506 that includes a plurality of logic modules, such as logic 510, 512, 514, 516, 518, or 520.

A tester 502 may be coupled to device 500 utilizing a standard chip interface 504, also called the physical interface, to test the various logic functions 506 of device 500. Standard chip interface 504 is a standard interface that conforms to the architectural interface standard. Standard interface 504 uses a standard link 522 that conforms to the architectural link standard. Standard link 522 includes a standard set of signal and control lines to communicate with tester 502.

Device 500 includes loopback test mode logic 508 that initiates within the various logic modules a variety of tests, and then reports the results to chip interface 504 for transmission to tester 502.

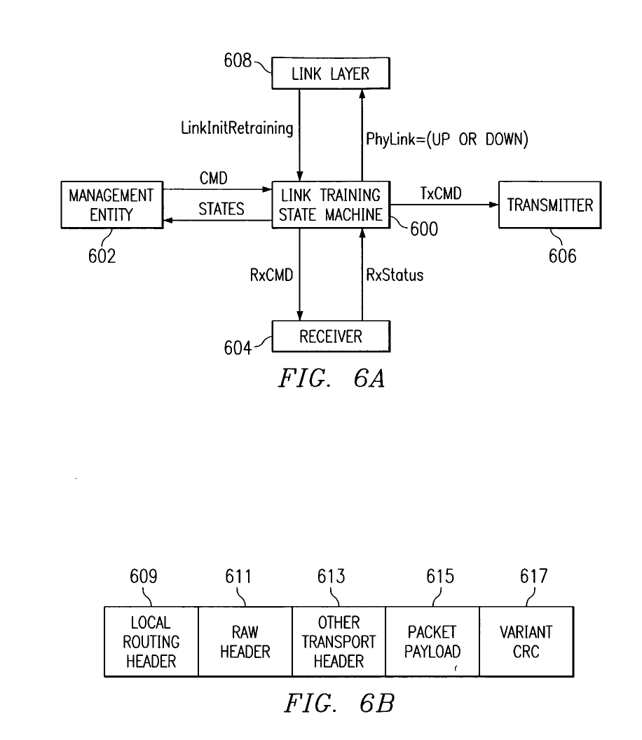

FIG. 6a illustrates a block diagram of a link training state machine 600 in accordance with the present invention. The link training state is entered by a system area network device when the device is being configured. Link training state machine 600 can communicate with management entity 602 by transmitting states and receiving commands. Link training state machine 600 also communicates with receiver 604 by transmitting commands and receiving a status, communicates with transmitter 606 by transmitting commands, and communicates with link layer 608 by transmitting a command “PhyLink=(up or down)” and receiving a “LinkInitRetraining” command.

FIG. 6b depicts a block diagram of a packet that may be used as an echo packet in accordance with the present invention. A loopback or echo packet can be an InfiniBand data packet or InfiniBand raw packet in which the test results are contained in the data payload of the packet. FIG. 6b depicts an InfiniBand raw packet type which contains a local routing header 609, raw header 611, other transport header 613, packet payload 615, and variant CRC 617. The headers are utilized for routing packets within the InfiniBand fabric. The test results in accordance with the present invention would be contained in packet payload 615.

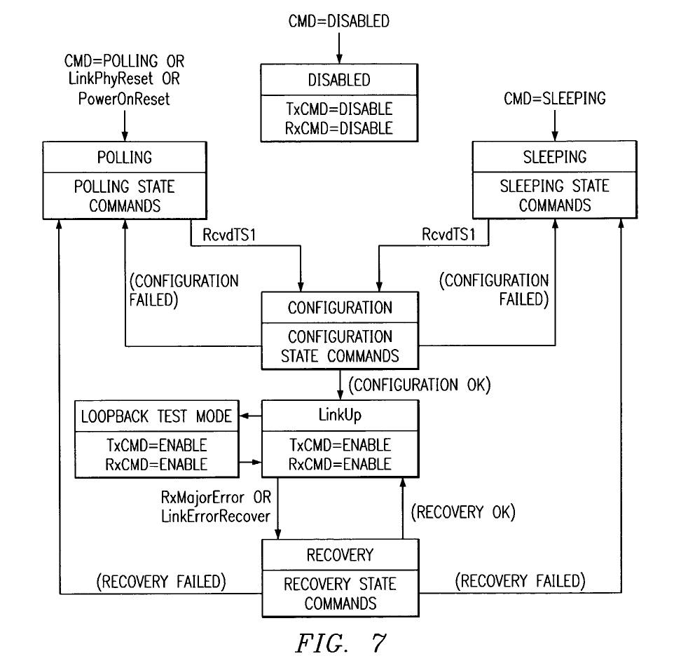

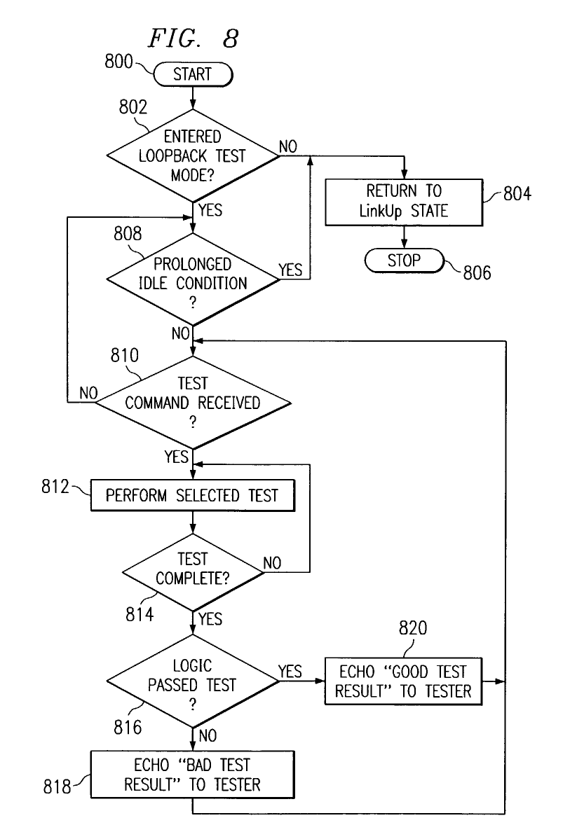

FIG. 7 depicts a more detailed block diagram of the link training state machine of FIG. 6a in accordance with the present invention. Link training state machine 600 has six standard primary states, and a new test mode state as described by the present invention. The six standard primary states are disabled, sleeping, polling, configuration, Linkup, and recovery. These six standard primary states are described in great detailed in the architecture specification “InfiniBand Architecture Release 1.0.a, Volume 1”, published Jun. 19, 2001, and available from the InfiniBand Trade Association (see InfiniBand web site at www.Infinibandta.org).

The LinkUp state is the normal link operation state. When the device is in this state, a port is available to transmit packets.

The present invention describes a new “Loopback Test Mode” state. When a device is in the LinkUp state, the device may enter the Loopback Test Mode state when the Loopback Test Mode commands “TxCMD” and “RxCMD” are both enabled. When these commands are enabled, the device may receive a test command within Loopback Test Mode Logic 508, execute the test, and then transmit a loopback, or echo, packet that includes the results of the test that was executed in response to the receipt of the test command.

FIG. 8 illustrates a high level flow chart which depicts testing logic modules included within a system area network device in accordance with the present invention. The process starts as depicted by block 800 and thereafter passes to block 802 which illustrates a determination of whether or not the Loopback Test Mode has been entered. As described by FIG. 7, the test mode may be entered while the device is in a “LinkUp” state when the transmit and receive commands of the Loopback Test Mode state are enabled. If a determination is made that the Loopback Test Mode has not been entered, the process passes to block 804 which depicts returning to the LinkUp state. The process then terminates as illustrated by block 806.

Referring again to block 802, if a determination is made that the Loopback Test Mode has been entered, the process passes to block 808 which depicts a determination of whether or not a prolonged idle condition has occurred. If a determination is made that a prolonged idle condition has occurred, the process passes back to block 804.

Referring again to block 808, if a determination is made that a prolonged idle condition has not occurred, the process passes to block 810 which depicts a determination of whether or not a test command has been received by Loopback Test Mode Logic 508. If a determination is made that a test command has not been received, the process passes back to block 808.

Referring again to block 810, if a determination is made that a test command has been received, the process passes to block 812 which illustrates Loopback Test Mode Logic 508 performing the selected test. The test command may specify one or more or all of the logic modules included within device functions 506. Next, block 814 depicts a determination by Loopback Test Mode Logic 508 of whether or not the test is complete. If a determination is made that the test is not complete, the process passes back to block 812.

Referring again to block 814, if a determination is made that the test is complete, the process passes to block 816 which illustrates a determination of whether or not the logic under test passed the selected test. If a determination is made that the logic under test did not pass the selected test, the process passes to block 818 which depicts the Loopback Test Mode Logic 508 generating an echo packet which includes an indication that the test was not passed. The echo packet is transmitted back to the tester including the test result. The process then passes back to block 810. Loopback or echo packets are two names used herein for the same packet type.

Referring again to block 816, if a determination is made that the logic under test did pass the selected test, the process passes to block 820 which depicts the Loopback Test Mode Logic 508 generating an echo packet which includes an indication that the test was passed. The echo packet is transmitted back to the tester. The process then passes back to block 810.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for testing a switched area network device having a standardized serial fabric interconnect and that includes a plurality of logic modules, said method comprising the steps of:
including test mode logic in said device;
receiving within said test mode logic via said standardized serial fabric interconnect a test command from a tester that is external to said device; and
testing, utilizing said test mode logic, at least one said plurality of logic in response to said receipt of said test command.

2. The method according to claim 1, further comprising the step of:
executing, by said test mode logic, said test command in response to said receipt of said test command.

3. The method according to claim 1, further comprising the step of:
transmitting via said standardized serial fabric interconnect a result of said testing.

4. The method according to claim 1, further comprising the steps of:
transmitting a result of said testing in an echo packet via said standardized serial fabric interconnect.

5. The method according to claim 1, further comprising the steps of:
including a test mode state within said device;
executing, by said test mode logic, said test command in response to said receipt of said test command; and
receiving, within said device, a command that causes said device to enter said test mode state, said test mode logic being capable of executing said test command only when said device is in said test mode state.

6. The method according to claim 5, further comprising the steps of:
including a link training state machine within said device, said link training state machine being entered when a link level of said device is being configured; and
including a test mode state within said link training state machine.

7. The method according to claim 1, further comprising the steps of:
executing, by said test mode logic, said test command in response to said receipt of said test command;
determining, utilizing said test mode logic, whether said at least one of said plurality of logic modules passed said test;
in response to a determination by said test mode logic that said at least one of said plurality of logic modules did pass said test, transmitting from said test mode logic to said tester an indication that said at least one of said plurality of logic modules did pass said test; and
in response to a determination by said test mode logic that said at least one of said plurality of logic modules did not pass said test, transmitting from said test mode logic to said tester an indication that said at least one of said plurality of logic modules did not pass said test.

8. The method according to claim 1, further comprising the steps of:
executing, by said test mode logic, said test command in response to said receipt of said test command;
determining, utilizing said test mode logic, whether said at least one of said plurality of logic modules passed said test;
in response to a determination by said test mode logic that said at least one of said plurality of logic modules did pass said test, transmitting from said test mode logic to said tester an indication within an echo packet that said at least one of said plurality of logic modules did pass said test; and
in response to a determination by said test mode logic that said at least one of said plurality of logic modules did not pass said test, transmitting from said test mode logic to said tester an indication within an echo packet that said at least one of said plurality of logic modules did not pass said test.

9. A method for testing a switched area network device having a standardized serial fabric interconnect and that includes a plurality of logic modules, said method comprising the steps of:
including test mode logic in said device;
including a link training state machine within said device, said link training state machine being entered when a link level of said device is being configured;
including a test mode state within said link training state machine;
receiving, within said device, a command that causes said device to enter said test mode state, said test mode logic being capable of executing a test command only when said device is in said test mode state;
receiving within said test mode logic via said standardized serial fabric interconnect a test command from a tester that is external to said device;
executing, by said test mode logic, said test command in response to said receipt of said test command;
determining, utilizing said test mode logic, whether said at least one of said plurality of logic modules passed said test;
in response to a determination by said test mode logic that said at least one of said plurality of logic modules did pass said test, transmitting from said test mode logic to said tester an indication that said at least one of said plurality of logic modules did pass said test; and
in response to a determination by said test mode logic that said at least one of said plurality of logic modules did not pass said test, transmitting from said test mode logic to said tester an indication that said at least one of said plurality of logic modules did not pass said test.

10. A system for testing a switched area network device having a standardized serial fabric interconnect and that includes a plurality of logic modules, said system comprising:
test mode logic included in said device;
a standardized serial fabric interconnect included in said device for receiving within said test mode logic a test command from a tester that is external to said device; and
said test mode logic for testing at least one said plurality of logic in response to said receipt of said test command.

11. The system according to claim 10, further comprising:
said test mode logic for executing said test command in response to said receipt of said test command.

12. The system according to claim 10, further comprising:
said standardized serial fabric interconnect for transmitting a result of said testing.

13. The system according to claim 10, further comprising:
said standardized serial fabric interconnect for transmitting a result of said testing in an echo packet.

14. The system according to claim 10, further comprising:
a test mode state included within said device;
said test mode logic for executing said test command in response to said receipt of said test command; and
said device for receiving a command that causes said device to enter said test mode state, said test mode logic being capable of executing said test command only when said device is in said test mode state.

15. The system according to claim 14, further comprising:
a link training state machine included within said device, said link training state machine being entered when a link level of said device is being configured; and
a test mode state included within said link training state machine.

16. The system according to claim 10, further comprising:
said test mode logic for executing said test command in response to said receipt of said test command;
said test mode logic for determining whether said at least one of said plurality of logic modules passed said test;
in response to a determination by said test mode logic that said at least one of said plurality of logic modules did pass said test, said test mode logic for transmitting to said tester an indication that said at least one of said plurality of logic modules did pass said test; and
in response to a determination by said test mode logic that said at least one of said plurality of logic modules did not pass said test, said test mode logic for transmitting to said tester an indication that said at least one of said plurality of logic modules did not pass said test.

17. The system according to claim 10, further comprising:
said test mode logic for executing said test command in response to said receipt of said test command;
said test mode logic for determining whether said at least one of said plurality of logic modules passed said test;
in response to a determination by said test mode logic that said at least one of said plurality of logic modules did pass said test, said test mode logic for transmitting to said tester an indication within an echo packet that said at least one of said plurality of logic modules did pass said test; and
in response to a determination by said test mode logic that said at least one of said plurality of logic modules did not pass said test, said test mode logic for transmitting to said tester an indication within an echo packet that said at least one of said plurality of logic modules did not pass said test.

18. A system for testing a switched area network device having a standardized serial fabric interconnect and that includes a plurality of logic modules, said system comprising:
test mode logic included in said device;
a link training state machine included within said device, said link training state machine being entered when a link level of said device is being configured;
a test mode state included within said link training state machine;
said device for receiving via said standardized serial fabric interconnect a command that causes said device to enter said test mode state, said test mode logic being capable of executing a test command only when said device is in said test mode state;
said test mode logic for receiving via said standardized serial fabric interconnect a test command from a tester that is external to said device;
said test mode logic for executing said test command in response to said receipt of said test command;
said test mode logic for determining whether said at least one of said plurality of logic modules passed said test;
in response to a determination by said test mode logic that said at least one of said plurality of logic modules did pass said test, said test mode logic for transmitting to said tester an indication that said at least one of said plurality of logic modules did pass said test; and
in response to a determination by said test mode logic that said at least one of said plurality of logic modules did not pass said test, said test mode logic for transmitting to said tester an indication that said at least one of said plurality of logic modules did not pass said test.

19. A computer program product in a data processing system for testing a switched area network device having a standardized serial fabric interconnect and that includes a plurality of logic modules, said computer program product comprising:
instruction means for including test mode logic in said device;
instruction means for receiving within said test mode logic via said standardized serial fabric interconnect a test command from a tester that is external to said device; and
instruction means for testing, utilizing said test mode logic, at least one said plurality of logic in response to said receipt of said test command.

20. The product according to claim 19, further comprising:
instruction means for executing, by said test mode logic, said test command in response to said receipt of said test command.

21. The product according to claim 19, further comprising:
instruction means for transmitting via said standardized serial fabric interconnect a result of said testing.

22. The product according to claim 19, further comprising:
instruction means for transmitting a result of said testing in an echo packet via said standardized serial fabric interconnect.

23. The product according to claim 19, further comprising:
instruction means for including a test mode state within said device;
instruction means for executing, by said test mode logic, said test command in response to said receipt of said test command; and
instruction means for receiving, within said device, a command that causes said device to enter said test mode state, said test mode logic being capable of executing said test command only when said device is in said test mode state.

24. The product according to claim 23, further comprising:
instruction means for including a link training state machine within said device, said link training state machine being entered when a link level of said device is being configured; and
instruction means for including a test mode state within said link training state machine.

25. The product according to claim 19, further comprising:
instruction means for executing, by said test mode logic, said test command in response to said receipt of said test command;
instruction means for determining, utilizing said test mode logic, whether said at least one of said plurality of logic modules passed said test;
in response to a determination by said test mode logic that said at least one of said plurality of logic modules did pass said test, instruction means for transmitting from said test mode logic to said tester an indication that said at least one of said plurality of logic modules did pass said test; and
in response to a determination by said test mode logic that said at least one of said plurality of logic modules did not pass said test, instruction means for transmitting from said test mode logic to said tester an indication that said at least one of said plurality of logic modules did not pass said test.

26. The product according to claim 19, further comprising:
instruction means for executing, by said test mode logic, said test command in response to said receipt of said test command;
instruction means for determining, utilizing said test mode logic, whether said at least one of said plurality of logic modules passed said test;
in response to a determination by said test mode logic that said at least one of said plurality of logic modules did pass said test, instruction means for transmitting from said test mode logic to said tester an indication within an echo packet that said at least one of said plurality of logic modules did pass said test; and
in response to a determination by said test mode logic that said at least one of said plurality of logic modules did not pass said test, instruction means for transmitting from said test mode logic to said tester an indication within an echo packet that said at least one of said plurality of logic modules did not pass said test.
